(19) United States
(12) Patent Application Publication
(10) Pub. No.: US 2025/0256299 A1
(43) Pub. Date: Aug. 14, 2025

(54) METHOD TO PRODUCE POWDER-COATED WOOD PANELS

(71) Applicant: LOUISIANA-PACIFIC CORPORATION, NASHVILLE, TN (US)

(72) Inventors: DAVID L. STACKHOUSE, NORTH WILES, NC (US); HEIDI TURNER, NASHVILLE, TN (US)

(21) Appl. No.: 19/050,027

(22) Filed: Feb. 10, 2025

Related U.S. Application Data
(60) Provisional application No. 63/551,716, filed on Feb. 9, 2024.

(51) Int. Cl. B05D 7/06; B05D 1/12

(52) U.S. Cl. CPC B05D 7/06; B05D 1/12

(57) ABSTRACT

A system and process for producing an engineered wood-based siding, cladding or panel with a top and edge powder-coat finish layer. The powder-coated product has a base layer with oriented wood flakes and/or strands, a fines layer applied to the top of the base layer, and an overlay layer, which may be a resin-impregnated paper overlay. The top or overlay layer may comprise primer on the top surface. The primer may extend down the edges of the base and fines layers. The powder-coat finish layer is applied in dry phase on the top surface and the edges.

This application claims benefit of and priority to U.S. Provisional App. No. 63/551,716, filed Feb. 9, 2024, which is incorporated herein in its entirety by specific reference for all purposes.

### FIELD OF INVENTION

This invention relates to a system and process for producing a powder-coated engineered wood-based siding, cladding or panel for exterior use.

### BACKGROUND OF INVENTION

Building wall and roof assemblies are layers of several materials, each performing one or more specific functions, that typically are installed separately on the construction sites. Proper installation of the various layers individually and in combination creates challenges not only for the designer, but also for the installers.

A typical layer in most such assembles is a wood panel product, or an integral composite engineered panel product, including, but not limited to, engineered wood composite products formed of lignocellulosic strands or wafers (sometimes referred to as oriented-strand board, or OSB). Products such as OSB have been found to be acceptable alternatives in most cases to dimension lumber or veneer-based wood paneling (e.g., softwood plywood). In general, wood-based composites are produced from wood particles bonded together by an adhesive, the adhesive being selected according to the intended use of, and the properties desired for, the composites. Often, the adhesive is combined with other additives to impart additional properties to the wood composites. Additives can include fire retardants, insecticides, water repellants, and preservatives. A significant advantage of wood-based composites is that they have many of the properties of plywood but can be made from lower grade wood species and waste from other wood product production, and can be formed into panels in lengths and widths independent of size of the harvested timber.

A major reason for increased presence in the marketplace of the above-described alternative product is that these materials exhibit properties like those of the equivalent dimension lumber or plywood, especially, the properties of retaining strength, durability, stability and finish under exposure to expected environmental and use conditions. A class of alternative products are multilayer oriented wood strand boards, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

U.S. patent application Ser. No. 16/780,726, U.S. Pub. 20200247002 A1, filed Apr. 24, 2020, discloses a process for manufacturing and finishing improved engineered wood siding, and is incorporated herein in its entirety by specific reference for all purposes. It describes an improved engineered wood product, along with several techniques and methods that, used separately or in combination, improve the actual and apparent surface quality of the improved engineered wood product. It includes manufacturing techniques to minimize the presence of sub-surface imperfections that may result in visible telegraphing on the exposed surface.

Following pressing, the engineered wood siding panels are cut into a variety and sizes depending on their end use product application, such as, but not limited to, lap, panel, trim, soffit, and vertical siding. As is known in the art, engineered-wood-based siding has been finished with water-based acrylic latex paint. The paint is applied in liquid phase, then solidifies by evaporating water and curing resins based on time, temperature and humidity. The time of application and curing can be substantial. After the paint cures, the siding is packaged and shipped to the storage and/or application sites.

### SUMMARY OF INVENTION

In various exemplary embodiments, the present invention comprises a system and process for producing an engineered wood-based siding, cladding or panel (e.g., manufactured with wood veneer, strands or fibers) with a top powder-coat finish layer. The powder-coated siding, cladding or panel comprises a base layer with oriented wood flakes and/or strands, a fines layer applied to the top of the base layer, and an overlay layer. The overlay layer may comprise a paper overlay or resin-impregnated paper overlay layer. The overlay layer may comprise primer on the top surface and/or edges. The primer may extend down the edges of the base and fines layers. A top powder-coat finish layer is applied in dry phase on the top surface and the edges.

A method for producing the siding, cladding or panel comprises the following steps:

Blank panels are produced or manufactured by pressing an engineered wood mat (which may be multilayer), an optional fines layer, and an optional overlay layer in a press under heat and pressure. The overlay layer may be added before pressing or after pressing. The overlay layer may comprise primer on the top surface and/or edges. In a preferred embodiment, the edges and the top surface or overlay are primed with a standard primer (e.g., standard acrylic primer).

Next, lap, panel and/or trim siding pieces are fabricated from the blank panels. Moisture content of the pieces is approximately 1% by weight. The lap, panel and/or trim siding pieces are then transported to the powder coat process facility. The transported siding pieces are stored and acclimated. Acclimation allows the moisture content of the pieces to increase to approximately 2%.

The siding pieces then are conveyed to a preheating station or oven. In several exemplary embodiments, the pieces are heated to a surface temperature of about 175 degrees to about 200 degrees F., and a moisture content of 3 to 5% at the surface. Preheating causes moisture in the piece to rise to the surface of the piece, which creates surface conductivity for the power coating process. The pins collectively support the pieces by contact with the underside of the pieces (which will not be powder coated, apart from minor overspray), leaving the sides and top surface exposed during the next step. In order to provide even distribution of the pins across the width of the pieces, the rods or slats can be different dimensions depending on the type of siding piece being treated (e.g., trim slats are smaller than lap slats).

The loaded pieces are then directed through a powder coating spray booth for application of the powder coating. The sprayers generally are located above the pieces, and positioned such that the desired thickness of powder coating adheres to the top surface and the side edges of each piece. Powder coating adheres to the surfaces of the pieces due to conductivity resulting from the surface moisture enhanced through the preheating step. Ideally, the spraying of the powder coating occurs within 2 minutes after the piece exists the preheating stage. The powder coating process itself takes under a minute for a batch of pieces.

The powder-coated pieces are then directed to a curing oven. The powder coating is cured so as to crosslink into a film on the coated surfaces of the piece. The pieces are then allowed to cool. In several embodiments, cooling lasts for approximately 2 minutes.

After cooling, the pieces are then prepared and packaged for shipping. In an embodiment, a stack of pieces (typically 6 to 8 in a stack) is formed, with every other piece flipped so that adjacent pieces are back-to-back (i.e., uncoated surface) or face-to-face (i.e., powder-coated upper surface), with slip sheeting placed between the adjacent powder-coated surfaces. The stack is then strapped or banded, and multiple stacks are palletized for storage and eventual shipment.

### BRIEF DESCRIPTION OF THE DRAWINGS

FIG. 1 shows a diagram of a manufactured wood siding product with a base layer with strand orientation, a fines layer, an overlay layer with primer, and a top powder-coat finish layer.

FIG. 2 shows a method of producing the powder-coated product of FIG. 1.

FIG. 3 shows a cutaway side view of the powder-coated product of FIG. 1, with powder-coating on the edges and top surface.

FIG. 4 shows a front view of an end of a fiberglass slat with pins for holding preheated siding pieces for conveyance through a powder booth.

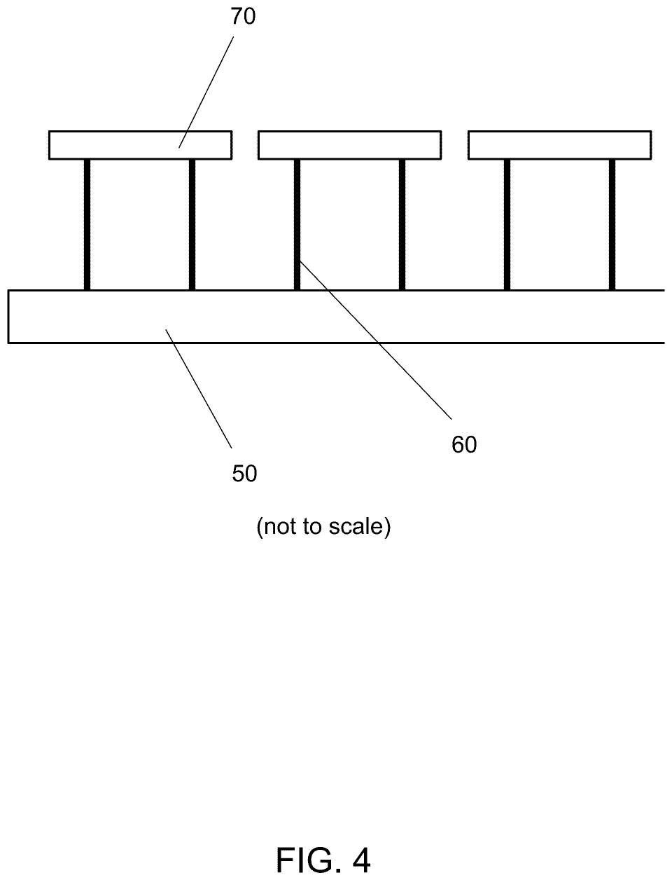

### DETAILED DESCRIPTION OF EXEMPLARY EMBODIMENTS

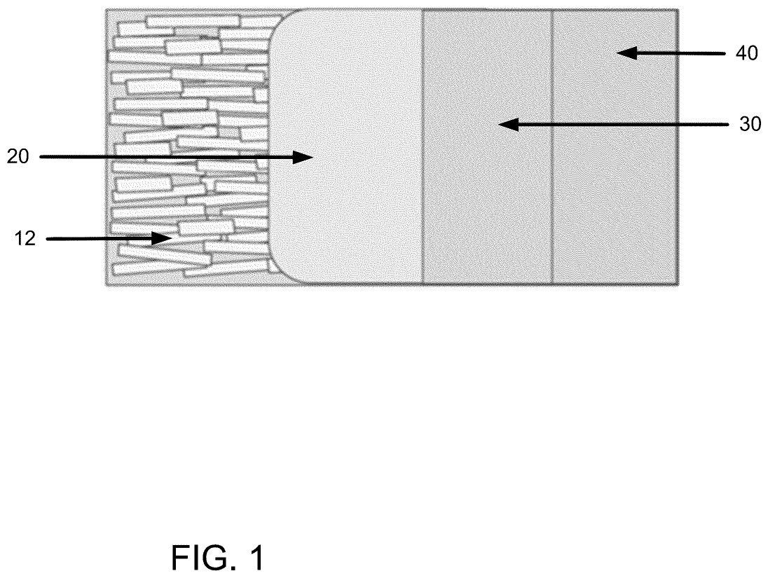

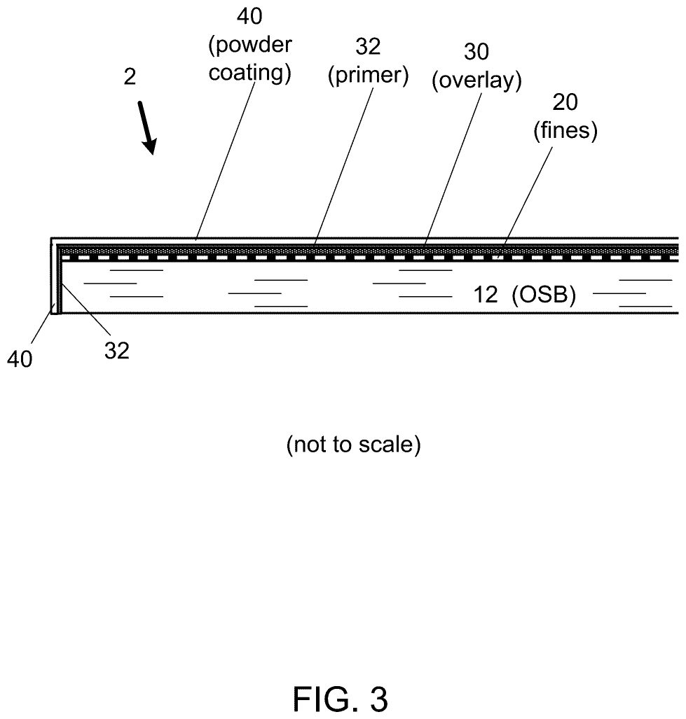

In various exemplary embodiments, the present invention comprises a system and process for producing an engineered wood-based siding, cladding or panel (e.g., manufactured with wood veneer, strands or fibers) with a top powder-coat finish layer. As seen in FIGS. 1 and 3, the powder-coated siding, cladding or panel 2 comprises a base layer 12 or substrate with oriented wood flakes and/or strands, a fines layer 20 applied to the top of the base layer, and an overlay layer 30. The overlay layer may comprise a paper overlay or resin-impregnated paper overlay layer. The overlay layer may comprise primer 32 on the top surface and/or edges. The primer may extend down the edges of the base and fines layers. A top powder-coat finish layer 40 is applied in dry phase on the top surface and the edges.

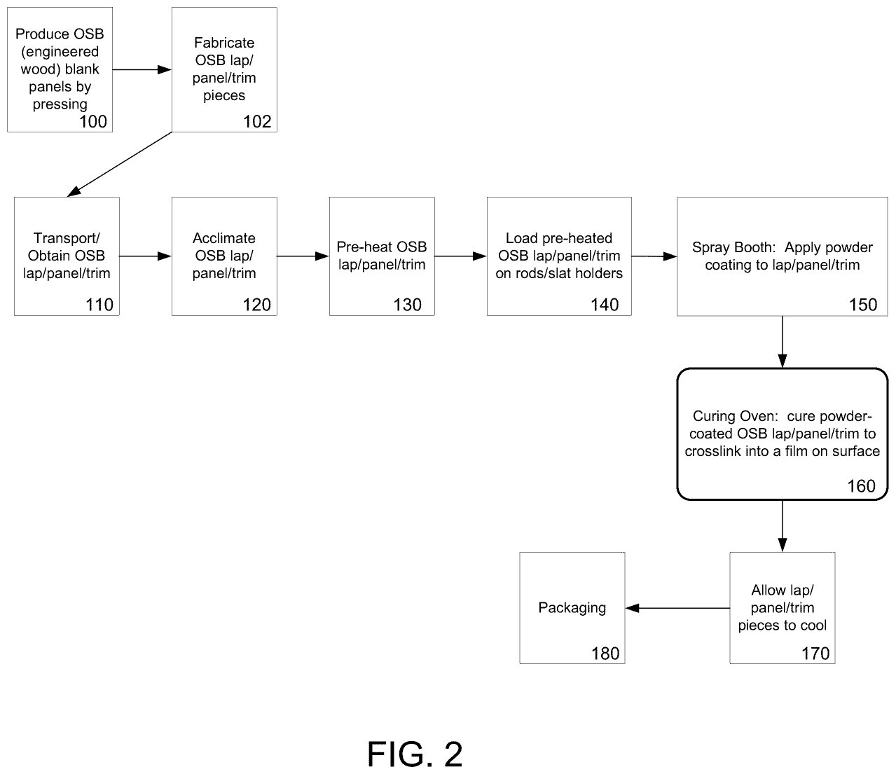

A method for producing the siding, cladding or panel of FIG. 1 comprises the following steps (as shown in FIG. 2):
1. Blank panels are produced or manufactured by pressing an engineered wood mat (which may be multilayer), an optional fines layer, and an optional overlay layer in a press under heat and pressure 100. The overlay layer may be added before pressing or after pressing. The overlay layer may comprise primer on the top surface and/or edges. In a preferred embodiment, the edges and the top surface or overlay are primed with a standard primer (e.g., standard acrylic primer).
2. Fabricate, from the blank panels, lap, panel and/or trim siding pieces 102. Moisture content of the pieces is approximately 1% by weight.
3. Transport the lap, panel and/or trim siding pieces to the powder coat process facility 110. The transported siding pieces are stored and acclimated 120. Acclimation allows the moisture content of the pieces to increase to approximately 2%.
4. The siding pieces then are conveyed to a preheating station or oven 130. In several exemplary embodiments, the pieces are heated to a surface temperature of about 175 degrees to about 200 degrees F., and a moisture content of 3 to 5% at the surface. Preheating causes moisture in the piece to rise to the surface of the piece, which creates surface conductivity for the power coating process.
5. The preheated siding pieces 70 are then loaded on holders comprising a nonconductive base rod or slat 50 with multiple vertical pins 60 (steel, aluminum, fiberglass, or the like) extending upward 140. The rods or slats are placed in parallel, spaced 2 inches apart, for the length of the conveyance (e.g., 48-50 slats are placed next to each other across a conveyance length). The pins are affixed to or through the base rod or slat, and extend upward 1.5 to 2 inches above the top of the rod or slat (or 2 to 3 inches above the conveyance surface). In one embodiment, the rods or slat are ¾″ in height. The pins collectively support the pieces by contact with the underside of the pieces (which will not be powder coated, apart from minor overspray), ensuring grounding and maintaining polarity of the pieces while moving from the preheating oven to the spray booth, and leaving the sides and top surface exposed during the next step. In order to provide even distribution of the pins across the width of the pieces, the rods or slats can be different dimensions depending on the type of siding piece being treated (e.g., trim slats are smaller than lap slats).
6. The loaded pieces are then directed through a powder coating spray booth for application of the powder coating 150. The sprayers generally are located above the pieces, and positioned such that the desired thickness of powder coating adheres to the top surface and the side edges of each piece. Powder coating adheres to the surfaces of the pieces due to conductivity resulting from the surface moisture enhanced through the preheating step. The pieces are spaced apart sufficiently to allow coating of the side edges (e.g., 1 to 3 inches of spacing between the edges of the siding pieces). Ideally, the spraying of the powder coating occurs within 2 minutes after the piece exists the preheating stage, as longer times will allow the surface moisture to move back to the interior of the pieces, thereby substantially reducing the ability of the powder coating to adhere to the piece. The powder coating process itself takes under a minute for a batch of pieces.
7. The powder-coated pieces are then directed to a curing oven 160. The powder coating is cured so as to crosslink into a film on the coated surfaces of the piece.
8. The pieces are then allowed to cool 170. In several embodiments, cooling lasts for approximately 2 minutes.
9. After cooling, the pieces are then prepared and packaged for shipping 180. In an embodiment, a stack of pieces (typically 6 to 8 in a stack) is formed, with every other piece flipped so that adjacent pieces are back-to-back (i.e., uncoated surface) or face-to-face (i.e., powder-coated upper surface), with slip sheeting placed between the adjacent powder-coated surfaces. The stack is then strapped or banded, and multiple stacks are palletized for storage and eventual shipment.

The pieces are thus powdered coated with a finish powder coat applied in dry phase to at least the top surface and edges of the siding pieces. The powder generally comprises particles of extruded polymer that cross-link. The powder can be colored with pigments. Additives may be added to impart desired characteristics to the coating and product, such as fire resistance (e.g., borates and/or phosphates), fungicides, insecticides mildew resistance, and moisture or bulk water resistance (e.g., plastics or polymers).

Further details and examples of methods, processes and systems for powder coating which may be used in the present invention are disclosed in U.S. Pat. No. 10,010,908 to IGP Pulvertechnik AG (issued Jul. 3, 2018), U.S. Pat. No. 10,344,379, to Valinge Innovation AB (issued Jul. 9, 2019), U.S. Pub. No. 2009/026366 to Ian Webb (pub. Oct. 22, 2009), and U.S. Pub. No. 2008/0188583 to Geoffrey Attenburrow, et al. (pub. Aug. 7, 2008), all of which are incorporated herein by specific reference for all purposes.

Testing may be performed prior to packaging and shipment. After completion of the powder coating process, color scans may be used to analyze the top surface and edge colors and gloss, and/or thickness of the coating, and ensure that these meet applicable standards and requirements, regardless of product texture.

As manufactured wood can expand and contract with changes in moisture, it is important that the finished wood pieces meet swell and cracking requirements. “Swell” is this context is the process of the expansion, and subsequent shrinkage, of the whole piece (i.e., wood substrate with powder coating). As the underlying wood expands and shrinks (swells), the powder coating need to expand and shrink with the board without cracking or similar damage. This is important as the product described herein is meant for external use and thus is exposed to the external environment factors such as rain, snow, heat, and other weathering conditions. Applicant has determined that consistent priming of the top surface/overlay as well as the edges with a standard primer (e.g., acrylic primer) will reduce swelling, particularly edge swelling, thereby preventing or reducing the occurrence of cracking on or along the edges.

Preferably, the swell range for an edge of a powder-coated piece described herein is from 2% to 5% (i.e., an increase in thickness of the edge from a standard state) using the 120-hour “kitchen cabinet test” as set forth in ASTM D2065-03 (edge swell only). For testing purposes, the test piece is exposed sideways, where only the edge is tested. A swell % in this range results in no cracking on the edge.

Similarly, the swell range for the entirety of the powder-coated pieces (i.e., “whole board swell”) is from 8% to 12%, using the weatherability of substrate test set forth in ASNII A135.6 Section 4 (cyclically soaking and drying the board, allowing water in from back of board). The powder coating is required to expand and shrink with the board as it swells, so that there is no or minimal cracking.

The weatherability of substrate with edge coat test (also knowns as the “cyclic wicking test”) is designed to evaluate the resistance to accelerated cyclic exposure conditions for an edge of the powder-coated product. Specimens are conditioned to equilibrium moisture content at 50%±1% relative humidity and 70° F.±2° F. The edge to be submerged in a water bath is measured at the center with a micrometer anvil, typically to the nearest 0.001″. The specimen is then suspended in a vertical position with a measured end in the water bath to a depth of depth of 1″±¼″ to start a cycle sequence. Samples are cycled in the following sequence:
Immerse sample end in 100° F. Deionized water for 18½ hours.
Place sample in a 220° F. oven (forced-air circulation) for 30 minutes.
Place sample in a freezer at 5° F. for 2 hours.
Place sample in the 220° F. oven for 30 minutes.
Place sample in the freezer at 5° F. for 2 hours.
Place sample in the 220° F. oven for 30 minutes.
   This cycle sequence is repeated a total of six times using fresh deionized water at the start of each cycle. After the sixth cycle, the specimen is re-conditioned to equilibrium moisture content under the same conditions given above, and the edge is measured again using calipers as described above to determine the percentage of swell.

Further, the specimen edge is examined for the presence of any defects or cracks. Any defects that are longer than ¼″ and not on the corners are considered “cracks.” The powder-coated product as described herein should exhibit no “cracks” (i.e., no defects longer than ¼″) after this reconditioning procedure.

The powder coating also should exhibit vapor permeability. Preferably, the vapor permeability of the powder coating without an OSB substrate (as determined by sanding down a coated board to a fine 0.15″ thickness to prepare a specimen) should be approximately 2 to approximately 6 gr/ft²*h (in Hg) according to the applicable ASTM E96/E96M-23 Procedure B water method.

This invention addresses the problem of the additional cost and time to produce a finished siding piece by liquid painting. The present invention also obviates the need to apply a final finish coating of paint after installation on a house or structure.

While the above description has referred to pieces of trim or siding in the form of lap siding, the process herein can be used to produce powder-coated manufactured wood products in other forms of structural cladding, or in the form of structural and non-structural panels, planks, and/or boards, all of which are within the scope of the present invention.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for manufacturing powder-coated manufactured wood siding, comprising:
providing a piece of manufactured wood siding with a top, a bottom, and edges therebetween, wherein said top and one or more of said edges are primed;
causing moisture in the piece of a manufactured wood siding to rise to surfaces on the top and edges;
loading the piece of manufactured wood siding on one or more holders, said one or more holders comprising a nonconductive base with a plurality of vertical pins to suspend the piece of manufactured wood siding above the base;
moving the loaded piece of manufactured wood siding through a powder coating spray booth;
applying a powder coating to said top and edges of the piece of manufactured wood siding as it moves through the powder coating spray booth; and
curing the powder-coated piece of manufactured wood.

2. The method of claim 1, wherein the piece of manufactured wood siding comprises oriented strand board (OSB).

3. The method of claim 1, wherein the piece of manufactured wood siding comprises lap siding, trim, or a panel.

4. The method of claim 1, wherein the step of preheating comprises heating the piece of manufactured wood siding in a preheating oven until a surface temperature is in the range of about 175 degrees F. to about 200 degrees F.

5. The method of claim 1, wherein the step of preheating comprises heating the piece of manufactured wood siding in a preheating oven until reaching a surface moisture content of about 3% to about 5%.

6. The method of claim 1, wherein the step of applying the powder coating occurs less than 2 minutes after the piece of manufactured wood siding is removed from the preheating oven.

7. The method of claim 1, wherein the step of curing comprises curing in a curing oven.

8. The method of claim 1, wherein the step of cooling lasts for approximately 2 minutes after curing.

9. The method of claim 1, comprising the step of stacking the cured powder-coated piece with other cured powder-coated pieces of manufactured wood siding.

10. The method of claim 9, wherein the step of stacking comprises forming a stack of six to eight pieces with every other piece flipped, and inserting slip sheeting between adjacent powder-coated top surfaces.

11. The method of claim 1, wherein the powder coating is colored.

12. The method of claim 1, wherein the powder coating comprises one or more additives.

13. The method of claim 12, wherein the one or more additives provide fire resistance.

14. The method of claim 12, wherein the one or more additives are fungicides.

15. The method of claim 12, wherein the one or more additives are insecticides.

16. A piece of powder-coated manufactured wood siding produced according to the method of claim 1, the manufactured wood siding comprising:
a piece of manufactured wood siding with a primed top, a bottom, and primed edges therebetween;
wherein the primed top and primed edges are coated with a contiguous powder coating, wherein the powder coating is vapor permeable, and expands and shrinks with the piece of manufactured wood siding within an edge swell range of from 2% to 5% without cracking.
